(19) United States
(12) Patent Application Publication
(10) Pub. No.: US 2006/0161513 A1
(43) Pub. Date: Jul. 20, 2006

(54) Method and a system for integrating semantic web services into an existing web service infrastructure

(76) Inventors: Christian Drumm, Karlsruhe (DE); Michael Altenhofen, Karlsruhe (DE)

Correspondence Address: BRAKE HUGHES PLC;c/o PORTFOLIOIP, P.O. BOX 52050, MINNEAPOLIS, MN, 55402, US

(21) Appl. No.: 11/314,979

(22) Filed: Dec. 21, 2005

(30) Foreign Application Priority Data
Dec. 22, 2004 (EP) 04030451.1

(51) Int. Cl. G06F 17/30

(52) U.S. Cl. 707/1; 707/100

(57) ABSTRACT

Techniques are described for integrating semantic web services into at least one existing web service infrastructure with an execution environment by placing a proxy component between the execution environment of the existing web service infrastructure and the semantic web services so that the execution environment invoking the proxy component can interact with semantic web services, the proxy component selecting services among the semantic web services based on a predefined goal, composing an executable service from the selected services, executing the executable service and returning the result of the service execution to the execution environment. Also described are an appropriate proxy component, a system for integrating semantic web services into at least one existing web service infrastructure and a computer program.

### CROSS-REFERENCE TO RELATED APPLICATIONS

This application claims priority under 35 U.S.C. § 119 to European Application No. 04030451.1, filed Dec. 22, 2004, and titled, “A METHOD AND A SYSTEM FOR INTEGRATING SEMANTIC WEB SERVICES INTO AN EXISTING WEB SERVICE INFRASTRUCTURE,” which is incorporated by reference herein.

### TECHNICAL FIELD

The present description relates generally to the field of semantic web services, and more particularly to a system and a method for integrating semantic web services into at least one existing web service infrastructure.

### BACKGROUND

An example goal of a specific architectural style, called service oriented architecture (SOA) is to achieve loose coupling among interacting software agents and to ease the reuse of existing application functionality exposed as (web) services in order to create new functionality or new applications. In addition, services may also be used in integrating applications across company boundaries. Although the ideas behind the service oriented architecture have been around for several years and different technologies can be used for implementing services, service oriented architecture has gained a lot momentum due to an emergence of XML (Extensible Mark-Up Language) and web services.

A web service is an interface that describes a collection of operations that are network-accessible through standardized XML messaging. A web service is described using a standard, formal XML notion, called its service description. It covers all the details necessary to interact with the service, including message formats, transport protocols and location. The interface hides the implementation details of the service, allowing it to be used independently of the hardware or software platform on which it is implemented and also independently of the programming language in which it is written. Web services fulfill a specific task or a set of tasks. They can be used alone or with other web services to carry out a complex aggregation or a business transaction.

Generally, web services may allow companies to reduce the cost of doing e-business, to deploy solutions faster and to open up new opportunities. Web services are based on a common program-to-program communications model, built on existing and emerging standards such as HTTP, XML, SOAP (Simple Object Access Protocol), WSDL (Web Service Description Language) and UDDI (Universal Description, Discovery and Integration). Web services allow applications to be integrated more rapidly, easily and less expensively than before.

Although early use of web services is peer-wise, it still addresses the problem of program-to-program communications including describing, publishing and finding interfaces. And, as the use of web services grows and the industry matures, more dynamic models of application integration will develop. Eventually systems integration through web services will happen dynamically at runtime. Just-in-time integration will herald a new era of business-to-business integration over the Internet.

Although the service oriented architecture, as already mentioned, provides one approach, it currently does not solve all integration problems. Data format mismatches, process mismatches and automatic service compositions are examples of such integration problems.

Currently, a lot of effort is put into research projects in the area of so-called semantic web and semantic web services. The semantic web is an extension of the current web in which information is given well-defined meaning, better enabling computers and people to work in cooperation. This meaning is provided by augmenting resources in the web with meta-data based on several standards like RDF (Resource Description Framework). The infrastructure of the semantic web would allow machines as well as humans to make deductions and organize information. Architectural components of the semantic web include semantics, that means meaning of elements, structure, which means organization of the elements, and syntax, which corresponds to communication.

Vendors of enterprise application platforms may support a usage and development of web services in their applications. In addition to enabling developers to develop and deploy services, these suites may contain workflow engines, enabling a creation of complex business processes from simple building blocks like simple web services. In the meantime many different languages for a description of complex business process on the basis of simple web services have been developed, as for example WSCI (Web Service Choreography Interface), XLANG, and, one of the most popular, BPEL4WS (Business Process Execution Language for Web Services). Those languages clearly define a data flow as XML documents, a control flow (block structured or transition based), a message flow (web services) and a transaction flow.

### SUMMARY

According to a general aspect(s), a method and a system for integrating semantic web services into existing web service infrastructures are provided.

Accordingly, a method is provided for integrating semantic web services into at least one existing web service infrastructure with an execution environment by placing a proxy component between the execution environment of the existing web service infrastructure and the semantic web services, so that the execution environment invoking the proxy component may utilize, or interact with, semantic web services for achieving a predefined goal. The proxy component may select services among the semantic web services based on the predefined goal, compose an executable service from the selected services, execute the executable service, and return the result of the service execution to the execution environment.

The invoking of the proxy component corresponds to a demand of a specific predefined goal. For each specific goal a user wants to achieve, a goal specific proxy component may be invoked which is specialized in achieving that specific predefined goal.

The composing of an executable service can be done, for example, in a form of a script. Such a script specifies a sequence of operations to be performed in order to achieve the predefined goal.

A proxy is an intermediary program that acts as both a server and a client for the purpose of making requests on behalf of other clients. Proxies are often used as helper applications for handling requests via protocols not implemented by a user agent. Therefore, a proxy functions as an intermediate link between a client application and a real server. It therefore may accept requests from clients, and transmit those requests on to the semantic web services environment.

Based on the description provided herein, a gradual transition from current already existing web service environments to semantic web service environments is possible. It is possible that a designer of a complex service wants to define some services exactly during design-time and leave others open for discovery during runtime. In the following this scenario is called a mixed usage scenario. Using the semantic web service environment described herein, mixed usage scenarios may be implemented, e.g., by placing a proxy between the execution environment and the semantic web services. During runtime an execution environment of the existing web service infrastructure, for example a BPEL (Business Process Execution Language) engine, calls the proxy component instead of a real service. The proxy component may then take care of discovering, selecting and invoking an appropriate semantic web service. These processes may be completely transparent to the execution environment. For the execution environment, all this functionality may be hidden behind a simple web service call. The proxy component, in some implementations, is not a generic execution environment but an object capable of discovering, selecting and invoking one specific kind of semantic web services. The proxy component may, for example, either be manually developed, or customizable service templates could be provided to a designer.

The proxy component may generally controlled by a controller when selecting, composing and executing a semantic web service. This controller is part of the proxy component. That means the controller is integrated within the proxy component.

Furthermore, it is possible that the predefined goal which can be achieved by invoking the proxy component is first divided into several sub-goals. This can be the case, for example, if the predefined goal of the proxy component can only be achieved by a composition of several web services, each achieving a specific sub-goal.

In an additional or alternative example embodiment, selecting services among the semantic web services is done by invoking a discovery unit which is external to the proxy component and listing the selected services into a list. The discovery unit may be part of the semantic web service environment. It can be a semantic web service itself.

Referring, for example, to “book travel” as a predefined goal to be achieved, a specific proxy component is called by an execution environment of an existing web service infrastructure, as for example by a travel portal. The proxy component first searches for a semantic web service based on the predefined goal by invoking a discovery unit which is part of a semantic web service environment. The discovery unit returns services that can achieve the corresponding sub-goals, in this example services capable of “booking flights”, services capable of “booking hotels” and services capable of “booking rental cars”. It is possible that further services offering further information about travel booking are discovered and returned to the proxy component. Furthermore, it is possible that two or more of those services are already semantically combined and merely some services are still left open for discovery. The services can then be registered within a list. Afterwards, the proxy component composes an executable service based on the specific predefined goal with the selected services stored within the list. The executable service, in this example, is then executed by invoking first a mediation unit of the semantic web service environment before invoking a real web service as a part of the composed service. The execution results are then returned to the travel portal which has called the proxy component first.

It has to be noted that the execution environment calls the proxy component instead of a real web service. The processes performed by the proxy component, namely discovering, selecting and invoking an appropriate semantic web service, are completely transparent to the execution environment. Thus, for the execution environment all this functionality may be hidden behind a simple web service call.

It is possible that composing the executable service comprises invoking a mediation unit to enable interoperability of the selected services. That means that during composing of an executable script, for example, invocations to a mediation unit may be inserted. After discovery, for each sub-goal a list of appropriate semantic web services stored within a selection unit of the proxy component may be available for achieving that sub-goal. Among those services, one is selected for each sub-goal. Then, a composition unit of the proxy component may compare the different services to be composed. The in- and output formats of the services are checked. It is possible that the different services match among each other. At best the in- and output formats are identical. In that case the services can be written one after the other within an appropriate script, so that they can easily be performed successively when executing that executable script.

In a second case, the in- and output formats of the different services do not match among each other. In that case, the composition unit may add a call to an external mediation unit within the corresponding script of the executable service, namely between the services.

In still another possible example embodiment, selecting services among the semantic web services may comprise a calculation of conformance of the selectable services with predefined selection criteria. Those selection criteria may also include user preferences.

Further, a proxy component for integrating semantic web services into at least one existing web service infrastructure may be provided. The proxy component may comprise a selection unit for selecting services among the semantic web services based on a predefined goal, a composition unit for composing an executable service from the selected services and an execution unit for executing the executable service.

The proxy component is locatable between a semantic web service environment and an existing web service infrastructure and accessible by an execution environment of the existing web service infrastructure.

It is possible that the proxy component comprises a controller for controlling the selection unit, the composition unit and/or the execution unit.

Furthermore, it is possible, that the proxy component has access to an external discovery unit and an external mediation unit. The external discovery unit and the external mediation unit are part of a semantic web service environment. Both can also be semantic web services themselves.

Furthermore, there may be a pool of semantic web services to which the proxy component has access. The proxy component may be specific for a certain kind of semantic web service(s). An execution environment calling the proxy component may thereby achieve a predefined specific goal. For each goal, a specific proxy component may be called in order to find or to create a semantic web service to achieve this predefined goal.

Furthermore, it is possible that a selection unit of the proxy component comprises a calculation unit for calculating conformance of selectable services with predefined selection criteria. Those selected criteria can also correspond to certain specific user preferences.

According to another general aspect, a system comprises semantic web services, an existing web service infrastructure and a proxy component such as described above. Within such a system, the proxy component may be placed between the semantic web services and an execution environment of the existing web service infrastructure, as described.

According to another general aspect, a computer program product with a computer-readable medium and a computer program stored on the computer-readable medium with a program code, that, when executed, causes the computer program to select semantic web services among a pool of semantic web services based on a predefined goal, compose an executable service from the selected services, execute the executable service, and return the result of the execution to an invoking execution environment.

According to another general aspect, a computer program includes a program code which is suitable for carrying out a method comprising at least selecting semantic web services among a pool of semantic web services based on a predefined goal, composing an executable service from the selected services, executing the executable service, and returning the result of the execution to an invoking execution environment.

According to another general aspect, an appropriate computer-readable medium has a computer program stored thereon, the computer program comprising a program code which is suitable for carrying out a method comprising at least selecting semantic web services among a pool of semantic web services based on a predefined goal, composing an executable service from the selected services, executing the executable service, and returning the result of the execution to an invoking execution environment.

For purposes of clarity, the present description refers to an abstract example of a web service environment. However, described examples of methods and systems may operate with a wide variety of types of network systems, including, for example, networks and communication systems dramatically different from the specific example described herein and/or illustrated in the following drawings.

Further, it should be understood that while the present description is provided in terms of a specific system, applications exist in a variety of communication systems, such as, for example, advanced cable-television systems, advanced telephone networks or any other communication system that would benefit from the described systems or methods. Thus, for example, it is intended that the system as used in the specification and claims be understood to include any communication system unless the context requires otherwise.

The details of one or more implementations are set forth in the accompanying drawings and the description below. Other features will be apparent from the description and drawings, and from the claims.

### BRIEF DESCRIPTION OF THE DRAWINGS

FIG. 1 is a sequence diagram of one example embodiment;

FIG. 2 is a flowchart of a further example embodiment.

### DETAILED DESCRIPTION

As semantic web services can be seen as one of the next evolutionary steps of current web service technology, at least two scenarios for an adoption of semantic web services in future business applications are possible. Either current web service environments may be augmented with semantic web services technology, or current web service environments are replaced by semantic web service enabled environments.

As companies have invested a lot of money in IT infrastructures it is much more likely that a transition will take place where first existing environments are augmented with semantic web services technology and thereby, after some time, the semantic web service enabled environment will be achieved. In order to allow such a transition, the semantic web services environment need to be defined flexible enough to support an augmentation of current environments as well as their future replacement.

As main building blocks for semantic web services ontologies, goals, mediators and web service descriptions are specified. Ontologies provide a common terminology used by other components, while web service descriptions specify capabilities and interfaces of the services, and mediators are used to overcome interoperability problems. Goals are used to express a client's desire. Goals may be achieved, for example, by decomposing them into sub-goals and then discovering web services capable of achieving the sub-goals. Such a goal decomposition might be a recursive process.

On an abstract level, a semantic web service environment may use (a) a discovery component to discover web services, (b) a mediation component to cope with heterogeneity on both the data and the process level, (c) a composition component to compose new semantic web services from either existing services or by specifying goals and the necessary composition, and (d) an execution unit for executing the semantic web services after they have been deployed. The mediation component may execute mappings between different data formats and processes that are created during composition. Components of an abstract semantic web service environment may need access to a semantic backbone that is offering access to ontologies and reasoning. Accordingly, a central, high-speed network for transporting such information between the different components may be provided.

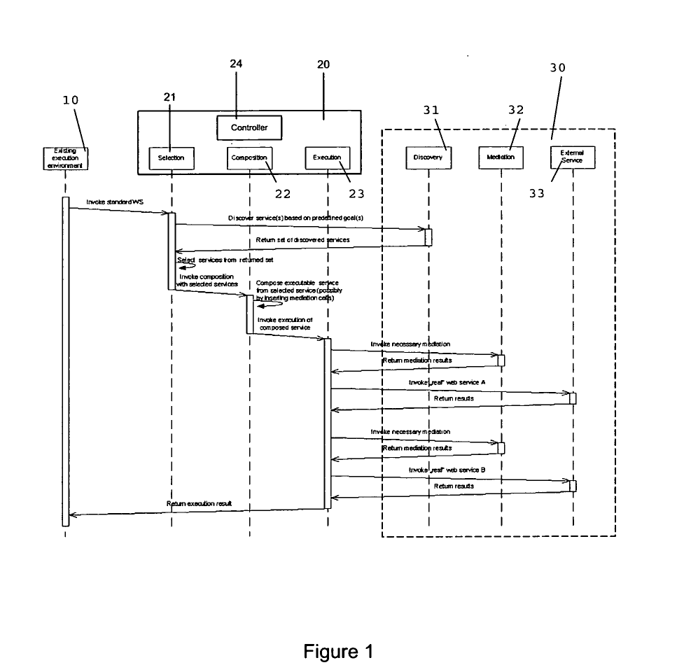

FIG. 1 shows a simplified view of an example method and proxy component. An execution environment 10 as shown may be considered to be part of an existing web service infrastructure. Furthermore, a proxy component 20 is shown. The proxy component 20 is placed between the execution environment 10 and a semantic web service environment 30. Within the semantic web service environment 30, a discovery unit 31, a mediation unit 32 and a pool of semantic web services 33 are arranged. The proxy component 20 comprises a selection unit 21, a composition unit 22 and an execution unit 23. There also may be a controller 24 within the proxy component 20, as shown in FIG. 1. Such a controller may be configured to control the execution of the selection, composition and execution of the proxy component 20. The execution environment 10 may invoke the proxy component 20 in order to achieve a predefined goal. Thus, the execution environment 10 may call the proxy component 20 instead of a standard web service. The herein-described processes performed by the proxy component 20, e.g., discovering, selecting and invoking an appropriate semantic web service, may thus be transparent to the execution environment 10. For example, for the execution environment 10, some or all of the described functionality may be hidden behind a simple standard web service call.

Such a goal may be, for example, “book travel”. For example, in order to create a travel booking service, the selection unit 21 of the proxy component 20 may first discover services based on that predefined goal by invoking the discovery unit 31. The overall goal “book travel” may need to be decomposed into specific adequate sub-goals. In case of “book travel”, for example, these sub-goals might be “book flight”, “book hotel” and “book rental car”. For each of said sub-goals the discovery unit 31 returns a set of discovered adequate services adapted to the particular sub-goals of the predefined goal. The selection unit 21 now selects services from the returned set of discovered services and invokes, in a next step, the composition unit 22 with the selected services. In one implementation, the selected services may be deposited by the selection unit 21 into a list.

Furthermore, the selection unit 21 may calculate conformance of the selected services with selection criteria or user preferences. The composition unit 22 may thus compose an executable service from the selected services. A script may be written according to which the executable service may be performed. In some implementations, the composition unit 22 may install mediation calls in order to guarantee interoperability of the selected services. After having composed an executable service, e.g., in form of a script, the composition unit 22 invokes the execution unit 23 for executing the composed service. The execution unit 23 may invoke, for executing the composed service, the mediation unit 32 for an associated mediation. The mediation unit 32 may thus be used to cope with heterogeneity on both data and/or process level. The mediation unit 32 may, for example, execute mappings between different data formats and processes that are created during design time. It is possible that the different semantic web services to be executed successively use, or are written in, different formats which are not compatible. The “booking flight”—service can use for example a date format as “day.month.year” while the “booking hotel”—service provides the date as “monthdayyear”. In such a case the mediation unit 32 may be used to match and consort the different formats. After mediation the execution unit 23 may invoke a corresponding real semantic web service from the pool 33 of semantic web services. In case that this semantic web service does not already cover exactly the whole service for achieving the predefined goal, the execution unit 23 may invoke a further real semantic web service from the pool 33 of semantic web services according to the script of the composed executable service in order to complete the composed service for achieving the predefined goal. Then the execution unit 23 may return the execution result to the execution environment 10, which has called the proxy component 20 for achieving the predefined goal.

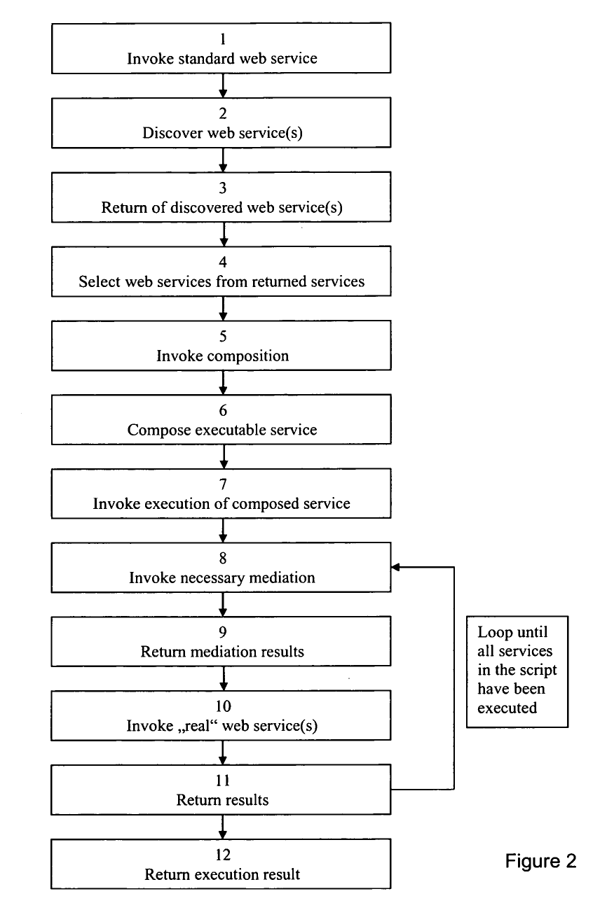

Referring to FIG. 2, a further specific example is illustrated using a schematic flowchart. In step 1 an execution environment of an existing service environment invokes a standard web service in order to achieve a specific goal, as, for example “cook lunch”. Because of lack of such a web service within the existing web service environment, a proxy component is invoked instead, in order to achieve the goal “cook lunch”. As already described, the execution environment thus calls the proxy component instead of a real web service. The processes performed by the proxy component may be completely transparent to the execution environment. For example, for the execution environment some or all this functionality may be hidden behind a simple web service call. The proxy component calls in step 2 a discovery unit to look for web services, which obey the predefined goal, i.e. web services for cooking. It is possible that the goal is first decomposed in sub-goals as for example “cooking recipes” and “buying opportunities (groceries)”. The discovery unit itself may be semantic if it provides not only a list of appropriate web services, but also information about the precise content of those services, i.e. vegetarian recipes or proposals for corresponding specific buying opportunities (groceries) to get the ingredients for the corresponding recipes. In that case the discovery unit represents a semantic web service itself. The discovery unit returns in step 3 a list of web services concerning lunch recipes and a list of services about groceries back to the proxy component.

Based on the predefined goal a selection unit of the proxy component identifies in step 4 those services which achieve specific sub-goals as for example “only vegetarian recipes” or “buy only in groceries situated near a given home”. The selection unit either uses semantic information already given by the discovery unit (e.g. vegetarian recipes, specific stores) or searches for an adequate recipe/store combination within the lists of services returned by the discovery unit. From that procedure, a list of services that have to be invoked according to a specific sequence, results. That list is forwarded in step 5 to a composition unit.

The composition unit generates in step 6 an executable service, e.g. in form of a script. The composition unit may identify the need for invoking a mediation unit because of incompatibilities between the selected services in the list. It therefore adds calls to an external mediation component into the executable script. Note that there might be a number of mediation services available, resulting in discovery and selection steps for the mediation component as described before.

Finally, an execution unit is invoked in step 7 which executes the executable service by invoking each service in the script. Therefore, in step 8 the mediation unit is invoked if necessary which returns in step 9 the corresponding mediation results. In step 10 the listed external services are invoked. The result, as for example a recipe together with an appropriate grocery, is returned in step 11 to the proxy component. When all steps within the script have been executed, the proxy component returns the result finally in step 12 to the execution environment.

In the following, a pseudo-code explains a further embodiment of an example method. It describes functionality of a controller, which is located inside the proxy component in order to control the execution of the selection, composition and execution of the proxy component.

onInvocation {

List selectedServices;

// For each of the subgoals that needs to be achieved by this
// proxy the controller asks the selection unit to find a list of
// services capable of solving this goal and select one
// The selected service is put into a list

foreach subgoal {

Set swservices = selection.findServices(subgoal);
SWS service = selection.selectService(swservices);
selectedServices.add(service);
}

// using the list of services the controller asks the
// composition unit to create an executable script. The composition unit
// might insert calls to mediation services to enable
// interoperability of the simple services

ExecutionScript script =
composition.composeService(selectedServices);

// the resulting script will be executed by the execution

result = execution.execute(script, inputData);

//finally the results of the service invocation is returned

return result;

}

The selection could be implemented as follows:

selectService (listOfServices){

foreach service in listOfService{
calculate conformance of service with
user preferences/selection criteria
}
return service with best conformance

}

The composition could be implemented as follows:

coposeService(orderdListOfSelectedServices) {

ExecutionScript script = new ExecutionScript( );
i=0; j=1;
// check if services can be composed
while (j < orderdListOfSelectedServices.lenght) do {

serviceA = orderdListOfSelectedServices.elementAt[i];
serviceB = orderdListOfSelectedServices.elementAt[j];
// check if servicesA (the one executed first) uses the same ouput
fomat
// as serviceB (the one executed afterwards) uses as input format
// A input/output format is equal if it uses the same XML syntax
and expressed
//according to the same ontology
if(serviceA.outputFormat unequal ServiceB.inputFormat){

mediationService=locateMediationService
(serviceA.outputFormat, serviceB.inputFormat);
// if no mediation service is found we can't construct an

execution script
if (mediationService = NULL) {

return ERROR;

}
// if a suitable mediation service is found we add the two
services and the
// necessary mediation service to the script.
else {

script.addStep(serviceA);
script.addStep(mediationService);
script.addStep(serviceB);

}

}

}
return script;

}

### Code Section 1

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

What is claimed is:

1. A method for integrating semantic web services into at least one existing web service infrastructure with an execution environment comprising:
receiving an invocation of a proxy component to interact with the semantic web services, the proxy component being associated with a pre-defined goal and located between an execution environment of the existing web service infrastructure and the semantic web services;
selecting services among the semantic web services based on the predefined specific goal;
composing an executable service from the selected services;
executing the executable service by first invoking a mediation unit of a semantic web service environment of the semantic web services before invoking one of the selected services as part of the composed service; and
providing a result of the service execution to the execution environment.

2. The method according to claim 1, wherein the executable service is described by a script specifying a sequence of operations to be performed.

3. The method according to claim 1, wherein the predefined goal is decomposed into several sub-goals.

4. The method according to claim 1, wherein selecting services among the semantic web services comprises:
invoking a discovery unit; and
listing the selected services within a list stored by the proxy component.

5. The method according to claim 1, wherein composing the executable service from the selected services comprises:
invoking a mediation unit to enable interoperability of the selected services.

6. The method according to claim 1, wherein selecting services among the semantic web services comprises:
calculating a conformance of the selectable services with predefined selection criteria.

7. A proxy component for integrating semantic web services into at least one existing web service infrastructure so as to achieve a predefined goal when the proxy component is invoked via a web service call, the proxy component comprising:
a selection unit configured to select services among the semantic web services based on the predefined goal, in response to an invocation by an execution environment of the existing web service infrastructure,
a composition unit configured to compose an executable service from the selected services in form of a script, and
an execution unit configured to execute the executable service by invoking the selected web services according to the script of the composed service, and further configured to return a result of the execution of the executable service to the execution environment of the existing web service infrastructure.

8. The proxy component according to claim 7, wherein the composition unit is configured to insert calls to a mediation unit into the script to enable interoperability of the selected web services.

9. The proxy component according to claim 7, which is located between a semantic web service environment and an existing web service infrastructure and which is configured to receive an invocation from an execution environment of the existing web service infrastructure.

10. The proxy component according to claim 7, further comprising a controller configured to control the selection unit, the composition unit and/or the execution unit.

11. The proxy component according to claim 7, the proxy component configured to access an external discovery unit and an external mediation unit.

12. The proxy component according to claim 7, wherein the selection unit further comprises:
a calculation unit configured to calculate conformance of selectable services of the semantic web services with predefined selection criteria.

13. The proxy component according to claim 7, the proxy component being included in a system comprising the semantic web services, the at least one existing web service infrastructure, wherein the proxy component is placed between the semantic web services and the execution environment of the existing web service infrastructure.

14. A computer program product with a computer-readable medium and a computer program stored on the computer-readable medium with a program code which, when executed, causes the computer program to:
select semantic web services from among a pool of semantic web services based on a predefined goal,
compose an executable service from the selected services,
execute the executable service, and
return a result of the execution to an invoking execution environment.
